(19) United States
(12) Patent Application Publication
(10) Pub. No.: US 2011/0171460 A1
(43) Pub. Date: Jul. 14, 2011

(54) Laminate and Method for the Production Thereof

(75) Inventors: Andreas Endesfelder, Overath (DE); Elaine Pereira, Wels (AT); Martin Burger, Traunstein (DE); Josef Binder, Krems (AT)

(73) Assignee: BOREALIS AGROLINZ MELAMINE GMBH, Linz (AT)

(21) Appl. No.: 12/990,250

(22) PCT Filed: Apr. 29, 2009
(86) PCT No.: PCT/EP2009/055209

§ 371 Date: Jan. 10, 2011

(30) Foreign Application Priority Data
Apr. 30, 2008 (DE) 10 2008 022 341.7

(51) Int. Cl. B32B 5/16; B32B 21/06; B32B 27/04; B32B 29/06; B32B 37/02; B32B 37/14; B82Y 30/00

(52) U.S. Cl. 428/331; 156/60; 977/773

(57) ABSTRACT

The invention relates to a laminate, the top layer thereof comprising a paper impregnated with an aminoplast resin and surface modified silica nanoparticles. According to the invention the surface modified silica nanoparticles comprise at least one silane on the surfaces thereof, said silane carrying at least one functional group. The invention further relates to a method for the production of a laminate of said type.

The invention relates to a laminate according to the preamble of claim 1, different methods for the production thereof according to the preamble of the claims 12, 13 and 14 and the use of a corresponding laminate according to claim 15.

Laminates have long been known for the application in the wood processing industry. They are for instance used for the production of floor coverings, wall coverings or furniture panels. The laminates have a layered construction, whereby the top layer consists mostly of a paper impregnated with an aminoplast resin. This can be a decor as well as an overlay paper. A decor paper is a special paper that serves for decorative coating of (wood) material. It is soaked or impregnated with plastic resins in printed or unprinted form and is subsequently laminated or concealed on the supporting material. An overlay paper serves the protection of the surface from external influences as scratches, scrapes or abrasion.

The lower layers or supporting layers can consist of further papers impregnated with different resins or of compact panels as for instance MDF (medium density fiber) or HDF (high density fiber) panels.

Laminates have very good properties in respect to storage stability, transparency, gloss or also grip. In respect to scratch resistance and in particular to microscratch resistance a further need for improvement in particular for the application in the floor and furniture area exists.

It is generally known to use for increasing the scratch resistance small, hard aluminium oxide particles, which are applied with the overlay paper. However, this is mostly connected with a loss of gloss and transparency of the laminate. Furthermore, the danger exists that the pressed plates used for the production of the laminate are being damaged by the particles.

EP 0 329 154 A1 describes the use of small, dry and hard particles, which are applied onto the already impregnated paper. The particles have a size of 1 to 80 μm. The improvement of scratch resistance is however accompanied with reduced gloss behaviour of the laminate.

EP 0 136 577 A2 describes the use of hard mineral nanoparticles, which are applied into the top layer of a laminate. If too little of the particles is applied, no sufficient effect onto the scratch resistance is recognized. However, if higher amounts of particles are applied, a veil of grey appears and a loss of gloss of the laminate occurs.

EP 1 584 666 A1 describes the use of particularly fine fillers, which are added to the aminoplast resin, with which the paper is impregnated. Laminates produced from such papers have an improved scratch resistance and it is still possible to obtain a glossy surface. However, only the resistance against large deep scratches is improved, almost no effect for the microscratch resistance is recognized. Furthermore, when using too large amounts of fillers a veil of grey can easily occur.

WO 03/040223 A1 describes the common use of nanoparticles and microparticles in order to improve the scratch resistance of a laminate. A very fine tuning of the amounts of nanoparticles and microparticles is here required in order to obtain the desired properties. Furthermore, the method is very complex.

US 2004/0116585 A1 describes the use of a mixture of an aminoplast resin and silica nanoparticles as additives in lacker. The goal is here to have an improved scratch resistance. However, no properties as gloss and transparencies are mentioned, also no application of the laminate is shown.

Object of the present invention is to provide a laminate, which has an improved stability against external influences, in particular an increased microscratch resistance compared to the prior art, by simultaneously maintaining the usual quality features of laminates, in particular by maintaining an essentially complete transparencies of aminoplast resin layer and maintaining the high gloss of the laminate.

This object is solved with a laminate having the features of claim 1. The laminate comprises as a top layer a paper impregnated with an aminoplast resin and surface modified silicium dioxide nanoparticles (silica nanoparticles). The top layer of the laminate is thereby a layer which faces directly the user of the laminate. Is the laminate for instance a floor covering, so is the top layer the layer of the laminate on which the user of the laminate moves. Is the laminate for instance a material of furniture, the top layer is the layer which usually faces a user on visible areas of the furniture (for instance the upper side of a table board, the side of a wardrobe or the seat of a chair). The upper side of the laminate can have different orientations in space, in particular in case of furniture.

The silicium dioxide nanoparticles are according to the invention surface modified with at least one silane, which carries at least one functional group. The functional group has thereby the effect to improve the compatibility between the aminoplast resin and the silicium dioxide nanoparticles.

In a variant such a laminate comprises at least two layers arranged on top of each other, namely an upper layer and at least one lower layer and/or a supporting layer. The layers arranged adjacent to each other, respectively, are connected with each other at least partially, in particular completely.

The functionalization of the silica nanoparticles occurs by silanization with appropriate functionalized silanes. The silanes react thereby with the silica nanoparticles under formation of covalent siloxane bonds (S—O—Si). Thus, surface modified silica nanoparticles are obtained by this method with the functionalized silane.

By using functionalized surface modified silica nanoparticles a greatly improved compatibility of the silica nanoparticles with the aminoplast resin matrix is achieved. The functional groups effect an improved compatibility with the resin matrix and can therefore partially or also completely react with the resin matrix and thus effect a covalent bonding of the silica nanoparticles to the resin matrix. But also if no covalent bonding occurs, the silica nanoparticles are bound via hydrogen bridges and Van-der-Waals interactions between the functional groups of the silica nanoparticles and for instance the methylol or methylether groups of the resin matrix.

Due to these effects a homogeneous distribution of the silica nanoparticles in the resin matrix occurs and therefore, an even distribution of the complete surface of the impregnated paper and therefore over the complete surface of the laminate produced therefrom. It is of particular advantage that on the surface exposed to the external influences a homogeneous and uniform distribution of the silica nanoparticles is present. Thereby it can be in particular recognized that the silica nanoparticles compensate the micro roughness of the surface since they are arranged preferably in the valleys of the surface. All this has the effect of a greatly improved resistance against small surface scratches and therewith a greatly improved microscratch resistance compared to the common laminates.

Suitable silane compounds for the modification are amongst others silanes, which contain an amino group, a hydroxyl group, an epoxid group, a glycidoxy group and/or a glycidoxypropyl group. Examples are gamma-glycidoxypropyl-trimethoxy-silane, gamma-glycidoxypropyl-methyldiethoxy-silane, (3-glycidoxypropyl)trimethoxy-silane, (3-glycidoxypropyl)hexyltrimethoxy-silane, beta-(3,4-epoxycyclohexyl)-ethyltriethoxy-silane. Further suitable silanes as well as the production of the surface modified silica nanoparticles are described in EP 1 554 220 A1 (WO 2004/035473 A1).

Silica nanoparticles are in particular preferred which were modified with gamma-glycidoxypropyl-trimethoxy-silane and/or gamma-glycidoxypropyl-methyldiethoxy-silane. Commercially available compounds are practically used as for instance bindzil CC30, CC40 or CC15.

The surface modified silica nanoparticles have in a variant an average particle diameter of ca. 2 nm to ca. 500 nm, in particular of ca. 3 nm to ca. 200 nm and specifically in particular of ca. 5 nm to ca. 60 nm.

The surface modified functionalized silica nanoparticles are thereby used in amounts of ca. 5% to ca, 70%, in particular of ca. 10% to ca. 50% and specifically in particular ca. 20% to ca. 30% in each case related to the amount of aminoplast resins. The percentage parameters are here like also in the following always to be understood as mass percentages, if not anything different explicitly mentioned.

Besides the described surface modified silica nanoparticles also further additives can be added to the aminoplast resin, as for instance post forming additives, wetting agents, hardeners, separating agents, etc.

Resins known to the person skilled in the art can be used as aminoplast resins, in particular melamine formaldehyde resins, melamine urea formaldehyde resins, urea formaldehyde resins or any mixtures thereof.

These resins can also be in a variant completely or partially etherified by alcohols, especially C₁- to C₄-alcohols, preferably methanol and/or butanol. The term aminoplast resin within the meaning of the invention is also to be understood as mixtures of one or multiple different resins.

An overlay paper as well as decor paper are suitable as papers for the top layer of the laminate. These as such known papers have such properties that they can be soaked or impregnated in a good fashion with an aminoplast resin. The overlay papers have advantageously an area weight of ca. 25 to ca. 60 g/m², preferably of ca. 25 to ca. 50 g/m². The decor papers have advantageously an area weight of ca. 25 to ca. 150 g/m², preferably of ca 10 to ca. 100 g/m².

A suitable supporting material for the top layer of the laminate is in a variant a support layer which comprises a kraft paper impregnated with a phenol resin. Thereby, the supporting layer can comprise a single or also a layer of multiple such impregnated craft paper. If multiple such layers are pressed with a top layer, so called compact boards are obtained. Kraft paper is known to the person skilled in the art generally as a paper of high resistance, in particular as paper with high tensile strength.

The supporting layer can also have alternatively or additionally one or multiple layers of further decor papers impregnated with aminoplast resin.

Common wood material boards as for instance MDF boards, HDF boards, chip boards, OSB- (oriented strand boards) boards or also solid wood boards are furthermore suited as material for the supporting layer. As material for the supporting layer preferably MDF and HDF boards as well as one or multiple layers of kraft paper are preferably used.

In a variant a counter paper is arranged on the backside of the supporting layer. The counter paper consists advantageously of a natron kraft paper impregnated with an aminoplast resin or another suitable paper.

It is additionally possible to arrange between the supporting layer and the top layer a further layer which is designated as lower layer. The top layer would be then connected to the lower layer and the lower layer would be connected to the supporting layer. Multiple lower layers are also conceivable.

The object of the invention is also being solved by a method with the features of claims 12 to 14. In such a method for producing a laminate a top layer is connected with a lower layer and/or a supporting layer, in particular by grouting under increased pressure and increased temperature. According to a first variant of the invention surface modified silica nanoparticles are mixed with an aminoplast resin solution for forming the top layer whereupon a paper is impregnated with this mixture.

The addition of surface modified silica nanoparticles can thereby occur by mixing a dispersion of the silica nanoparticles with the solution of the aminoplast resin. The silica nanoparticles are thereby at first dispersed in a dispersion agent. Suitable dispersion agents are for instance water, but also other liquids, in particular polar solvents as for instance diethylene glycol, monoethylene glycol, butanediol, butanol, dipropylene glycol methyl ether, propylene glycol methyl ether, propylene glycol butyl ether, propylene glycol methyl ether acetate or isopropanol. Thus, in particular aqueous solution of a modifying agent as for instance a surfactant, thickening agent, release agent and/or hardener can also be used as dispersion agent. The dispersion can contain one or more of the previously mentioned substances in any combination. The modifying agent can also be contained in the solution of the aminoplast resin.

By mixing of the dispersion of the silica nanoparticles with the solution of the aminoplast resin preferably a homogeneous mixture is obtained. Due to the functional groups present on the surface of the silica nanoparticles, which effect a good compatibility with a resin, this is essentially facilitated.

The silica nanoparticles can alternatively also be present in a heterogeneous manner in the aminoplast resin solution. However, in this case no precipitation in the aminoplast resin solution is formed by any means. Rather, the mixture shows a slight clouding and/or an increased light diffusion. If the silica nanoparticles are present in heterogeneous form in the aminoplast resin solution, a homogeneous mixture or distribution of the silica nanoparticles in the aminoplast resin is however formed latest in the impregnation step and/or in the pressing step.

The addition of surface modified silica nanoparticles can also occur in a second variant already during the synthesis of the aminoplast resin. Aminolast resins are synthesized with methods known to the person skilled in the art. The silica nanoparticles can thereby be added at any step of the resin synthesis. Also in this case the functional groups on the surface of the silica nanoparticles effect a greatly improved compatibility with the aminoplast resin. It can also occur that the silica nanoparticles react via these functional groups with a resin matrix and are thus covalently bonded to the resin.

According to a third variant it is provided that the surface modified silica nanoparticles are only applied to the paper already impregnated with the aminoplast resin. For this reason a suitable dispersion of the surface modified silica nanoparticles can be sprayed if the paper had already been impregnated with the aminoplast resin. Suitable dispersion agents for such dispersion are again for instance water, but also other liquids, in particular polar solvents as for instance diethylene glycol, monoethylene glycol, butanediol, butanol, dipropylene glycol methyl ether, propylene glycol methyl ether, propolene glycol butyl ether, propylene glycol methyl ether acetate or isopropanol. Thus, an in particular aqueous solution of a modifying agent as for instance a surfactant, a thickening agent, a release agent and/or hardener can be also used as dispersion agent. The dispersion can also contain one or multiple of the previously mentioned substances in any combination. The modifying agents can also be contained in the mixture of the silica nanoparticles with the second aminoplast resin.

The already impregnated paper can be still wet or already pre-dried or also completely dried while applying the silica nanoparticles. The spraying can thereby be carried out with suitable apparatuses known to the person skilled in the art.

Alternatively it is also possible to apply a mixture of surface modified silica nanoparticles and a second aminoplast resin producible according to the above-mentioned methods onto the paper already impregnated with a first aminoplast resin. The first aminoplast resin is thereby the aminoplast resin which was simply designated as aminoplast resin in the present description. Thus, this mixture can be sprayed onto the paper already impregnated with the aminoplast resin. The already impregnated paper can be thereby still wet or already be pre-dried or also be completely dried. The spraying can thereby occur using suitable apparatuses known to the person skilled in the art. The (second) aminoplast resin present in the mixture and the (first) aminoplast resin used for impregnating the paper can thereby be similar or different.

Further variants of the claimed method result from the above-explained variants and embodiments of the claimed laminate, which also are valid analogue to the method.

The laminate according to the invention is suitable for using a floor covering, table board or in general in the production of furniture for production of further furniture.

The invention is explained in more detail by the means of the following examples.

### EXAMPLE 1

In a 2 l round bottom flask 350 g of 37% formaldehyde solution with 120 g water are mixed. 211 g of 52% silica nanoparticle dispersion are added to this mixture and the obtained mixture is stirred thoroughly. The silica nanoparticles have an average diameter of 7 nm and are stabilized by the conversion with gamma-glycidoxypropyl-trimethoxysilane, so that they carry a number of epoxy groups on the surface. The structural formula of gamma-glycidoxypropyl-trimethoxysilane is given in the following:

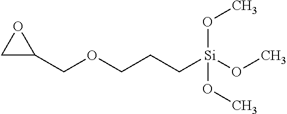

310 g melamine are added to this mixture and heated fast to 93° C. while stirring strongly. It has to be kept in mind that the pH value stays at 8.8±0.2. If necessary, the pH value is adjusted by adding NaOH.

The reaction mixture is further condensed until a water tolerance of 2.3 is obtained; then it is cooled down to room temperature. A clear and stable resin solution is obtained.

### EXAMPLE 2

In a 2 l round bottom flask 350 g of 37% formaldehyde solution are mixed with 135 g water. 310 g melamine are added to this mixture and heated fast to 93° C. while stirring strongly. It has to be kept in mind to keep the pH value at 8.8±0.2. If necessary, the pH value id adjusted by addition of NaOH.

The reaction mixture is further condensed until a water tolerance of 2.3 is obtained; then it is cooled down to room temperature.

211 g of a 52% silica nanoparticle dispersion are added to the cooled resin solution and strongly stirred with each other. The silica nanoparticles have an average diameter of 7 nm and are stabilized by the conversion with gamma-glycidoxypropyl-trimethoxysilane, so that they carry a number of epoxy groups on the surface. A clear and stable resin solution is obtained.

### COMPARATIVE EXAMPLE 1

In a 2 l round bottom flask 350 g of 37% formaldehyde solution are mixed with 135 g water. 310 g melamine are added to this mixture and heated fast to 93° C. while stirring strongly. It has to be kept in mind that the pH value has to be at 8.8±0.2. If necessary, the pH value id adjusted by addition of NaOH.

The reaction mixture is further condensed until a water tolerance of 2.3 is achieved; then it is cooled down to room temperature.

211 g of a 52% silica nanoparticle dispersion are added to the cooled resin mixture and are strongly stirred with each other. The silica nanoparticles have an average diameter of 7 nm and are not further modified. This means they thus carry no further functional groups.

In this case a cloudy solution is obtained from which after short time a white solid precipitates.

### EXAMPLE 3

It is proceeded in analogy to example 2, only that such particles are used as silica particles which where functionalized with beta-(3,4-epoxycyclohexyl)-ethyltriethoxy-silane. The structural formula of beta-(3,4-epoxycyclohexyl)-ethyltriethoxy-silane is provided in the following:

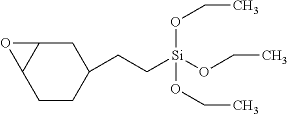

A stable clear solution is also obtained.

### EXAMPLE 4

It is proceeded in analogy to example 2, only that such particles where used as silica particles which where functionalized with aminopropyl-triethoxy-silane. The structural formula of aminopropyl-triethoxy-silane is provided in the following:

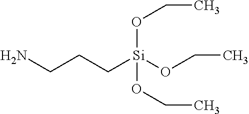

A stable clear solution is also obtained.

### EXAMPLE 5

A decor paper (80 g/m²; company Technocell) is impregnated with the resin of example 1 so that a resin amount of 110% is obtained, whereby 0.3% surfactant (Hipe®add Nu04, AMI) and 0.5% hardener (Hipe®add A462, AMI) were added to the resin shortly before the impregnation of the decor paper.

The impregnated decor paper is dried to residual moisture of 7%. Subsequently the impregnated decor paper is grouted together with three layers of a phenol resin impregnated kraft paper and an opposite layer with a pressure of 80 bar at 150° C. for two minutes and is subsequently cooled to 70° C.

### EXAMPLE 6

It is proceeded in analogy to example 5, whereby the resin of example 2 is used as resin.

### EXAMPLE 7

It is proceeded in analogy to example 5, whereby the resin of example 3 is used as resin.

### EXAMPLE 8

It is proceeded in analogy to example 5, whereby the resin of example 4 is used as resin.

### COMPARATIVE EXAMPLE 2

It is proceeded in analogy to example 5, whereby as resin a standard melamine formaldehyde resin (Standard-MF-Resin) is however used. The synthesis of such a resin is known to a person skilled in the art. It is conducted in analogy to example 2, whereby the addition of silica nanoparticles is disclaimed.

### EXAMPLE 9

A decor paper (80 g/m²; company Technocell) is impregnated with the resin of example 2 so that a resin amount of 110% is obtained, whereby 0.3% surfactant (Hipe®add Nu04, AMI) and 0.5% hardener (Hipe®add A462, AMI) is added to the resin shortly before impregnation.

The impregnated decor paper is dried to residual moisture of 6%. Subsequently, the impregnated paper is grouted with a pressure of 30 bar at a temperature of 180° C. for 30 s onto a MDF board.

### EXAMPLE 10

A decor paper (80 g/m²; company Technocell) is impregnated with a Standard-MF-Resin (see comparative example 2), so that the resin amount of 110% is obtained. The impregnated decor paper is dried to residual moisture of 7%.

The dried paper is sprayed with an aqueous dispersion of silica nanoparticles as used in example 1, so that an amount of 20 g/m² of silica nanoparticles is obtained. Subsequently the decor paper is grouted in analogy to example 5.

### EXAMPLE 11

A decor paper (80 g/m²; company Technocell) is impregnated with a Standard-MF-Resin (see comparative example 2) so that a resin amount of 110% is obtained. The impregnated decor paper is dried to residual moisture of 7%.

The dried impregnated paper is sprayed with a resin solution with silica nanoparticles of example 2, so that an amount of 20 g/m² of silica nanoparticles is obtained. Subsequently the decor paper is grouted in analogy to example 5.

The microscratch resistance of the obtained laminates of the examples 5 to 11 and the comparative example 2 were tested with the aid of a Taber Abraser. For this purpose a rotational velocity of 60 U/min with a pressure strength of 500 g were chosen by using a S33-sand paper and two rotational cycles (720° C. rotation of the grinding wheel of the Taber Abraser) were conducted. Subsequently the surface was evaluated visually and placed into the following classes:

1: no visible change of the surface
2: slightly visible fine scratches
3: visible fine scratches
4: visible deep scratches
5: very deep scratches

A measurement of gloss differences before and after the scratch test was also conducted. The gloss measurement was conducted with a TRI Gloss Master (Sheen Instruments GB). Thereby the amount of reflected light of a sample to be tested in comparison to a black standard sample is measured. The amount of light reflected from the standard sample corresponds thereby to 100 units. The light was irradiated in an angle of 60° to the lot of the sample for the gloss measurements and the light reflected in this angle was measured.

The results of the determination of the scratch resistance and the gloss differences of the different laminates can be seen in the following table 1.

TABLE 1
Determination of the scratch resistance and the gloss
differences of the different laminates

| Laminate from | Visual characterization | Loss of gloss [%] |
|---|---|---|
| Example 5 | 2 | 13.0 |
| Example 6 | 2-3 | 16.8 |
| Example 7 | 2-3 | 15.4 |
| Example 8 | 1-2 | 11.8 |
| Example 9 | 2-3 | 16.4 |
| Example 10 | 1-2 | 12.3 |
| Example 11 | 1 | 8.6 |
| Comparative Example 2 | 3-4 | 35.3 |

Further laminates were produced according to the following examples 12 to 14 and according to the comparative examples 3 to 6.

### EXAMPLE 12

A decor paper (80 g/m²; company Technocell) is impregnated with a Standard-MF-Resin (see comparative example 2), so that a resin amount of 110% is obtained. The impregnated decor paper is dried to residual moisture of 5.0%.

The dried paper is sprayed with a 23% aqueous dispersion of silica nanoparticles (w/V) that means 23 mass percent silica nanoparticles in water or alternatively in an aqueous solution of a dispersion agent corresponding to the above explanation), so that an amount of 20 g/m² of silica nanoparticles is obtained. Subsequently, the decor paper is grouted in analogy to example 9.

### COMPARATIVE EXAMPLE 3

It is proceeded in analogy to example 12, only that no silica nanoparticles are sprayed.

### EXAMPLE 13

A decor paper (80 g/m²; company Technocell) is impregnated with a Standard-MF-Resin (see comparative example 2) so that a resin amount of 110% is obtained. The impregnated decor paper is dried to a residual moisture of 10%.

The dried paper is sprayed with a 23% aqueous dispersion of silica nanoparticles (w/v) according to example 12, so that an amount of 20 g/m² of silica nanoparticles is obtained. Subsequently, the decor paper is grouted in analogy to example 9.

### COMPARATIVE EXAMPLE 4

It is proceeded in analogy to example 13, only that no silica nanoparticles are sprayed.

### EXAMPLE 14

An overlay paper (25 g/m²; company Schöller & Hösch) is impregnated with a Standard-MF-Resin (see comparative example 2) so that a resin amount of 220% is obtained. The impregnated decor paper is dried to residual moisture of 7.0%.

The dried paper is sprayed with a 23% aqueous dispersion of silica nanoparticles (w/v) according to example 12, so that an amount of 20 g/m² of silica nanoparticles is obtained. Subsequently, the decor paper is grouted in analogy to example 9.

### COMPARATIVE EXAMPLE 5

It is proceeded in analogy to example 14, only that no silica nanoparticles are sprayed.

### EXAMPLE 15

An overlay paper (25 g/m²; company Schöller & Hösch) is impregnated with a Standard-MF-Resin (see comparative example 2) so that a resin amount of 220% is obtained. The impregnated decor paper is dried to residual moisture of 11.0%.

The dried paper is sprayed with a 23% aqueous dispersion of silica nanoparticles (w/v) according to example 12, so that an amount of 20 g/m² of silica nanoparticles is obtained. Subsequently, the decor paper is grouted in analogy to example 9.

### COMPARATIVE EXAMPLE 6

It is proceeded in analogy to example 15, only that no silica nanoparticles are sprayed.

The microscratch resistance and the gloss changes of the obtained laminates of the examples 12 to 15 and the comparative examples 3 to 6 were tested according to the company standard “IHD-W-445 Version Mai 2007” of the Institute of Wood Technology Dresden GmbH (IHD). This company standard is a test procedure for determining the resistance of an object to be tested against multiple scratchings. The company standard of the version August 2006 deviating slightly from the company standard of the version May 2007 in respect to the diameter of the used grinding plate and further details is also described in a publication (R. Emmler (2007): “Kratz-Testat”, Laminat-Magazin, page 76-78).

The results of the tests of the microscratch resistance and the gloss changes or the entered gloss loss of the laminates of the examples 12 to 15 and the comparative examples 3 to 6 are summarized in the following table 2.

TABLE 2
Determination of scratch resistance and gloss loss of different laminates

| | Loss of gloss in percent | | | |
|---|---|---|---|---|
| | Test at | Test at | Test at | Evaluation level of |
| Laminate from | 20° C. | 60° C. | 85° C. | scratch picture |
| Example 12 | 7.8 | 5.7 | 0.2 | 1 |
| Comparative | 76.2 | 60.0 | 15.9 | 5 |
| Example 3 | | | | |
| Example 13 | 8.3 | 3.7 | 2.6 | 1 |
| Comparative | 67.2 | 44.9 | 10.6 | 5 |
| Example 4 | | | | |
| Example 14 | 15.3 | 6.9 | 1.2 | 2 |
| Comparative | 63.2 | 45.5 | 9.2 | 5 |
| Example 5 | | | | |
| Example 15 | 16.6 | 9.9 | 1.0 | 2 |
| Comparative | 35.5 | 19.2 | 3.1 | 4 |
| Example 6 | | | | |

1-15. (canceled)

16. A laminate, the top layer thereof comprising a paper impregnated with an aminoplast resin and surface modified silica nanoparticles, the surface modified silica nanoparticles comprising on their surface at least one silane, carrying at least one functional group, wherein on the surface of the laminate a homogeneous and uniform distribution of the silica nanoparticles is present.

17. The laminate according to claim 16, wherein it comprises at least two layers arranged on top of each other and being at least partially connected with each other.

18. The laminate according to claim 16, wherein the functional group is selected from the group comprising amino, hydroxy, epoxide, glycidoxy and glycidoxypropyl groups.

19. The laminate according to claim 16, wherein the surface modified silica nanoparticles have an average diameter of 2 nm to 500 nm.

20. The laminate according to claim 16, wherein the top layer comprises the surface modified silica nanoparticles in an amount of 5% to 70%, in respect to the amount of aminoplast resin.

21. The laminate according to claim 16, wherein a melamine formaldehyde resin, a melamine urea resin, a urea formaldehyde resin or any mixture thereof is used as aminoplast resin.

22. The laminate according to claim 21, wherein the aminoplast resin is completely or partially etherified with at least one alcohol.

23. The laminate according to claim 22, wherein the alcohol used for the etherification is a C₁-C₄ alcohol.

24. The laminate according to claim 16, wherein the paper is an overlay paper or a decor paper.

25. The laminate according to claim 16, wherein the laminate comprises a supporting layer, which comprises one or multiple layers of kraft paper impregnated with phenol resin.

26. The laminate according to claim 16, wherein the laminate comprises a supporting layer, which comprises a MDF, HDF, OSB, chip or solid wood board.

27. A method for producing the laminate according to claim 16, whereby a top layer is connected with a lower layer and/or a supporting layer, wherein for forming a top layer of a laminate, a dispersion of surface modified silica nanoparticles in a dispersion agent is applied on a paper already being impregnated with an aminoplast resin.

28. The method according to claim 27, wherein the dispersion agent is chosen from the liquids of the group comprising water, polar solvents, in particular diethylene glycol, monoethylene glycol, butanediol, butanol, dipropylene glycol methylether, propylene glycol methylether, propylene glycol butyl ether, propylene glycol methyl ether acetate or isopropanol, and solutions of a modifying agent, a thickening agent, a release agent and/or a hardener.

29. The method according to claim 27, wherein a combination of at least one of the liquids of the group comprising water, polar solvents, in particular diethylene glycol, monoethylene glycol, butanediol, butanol, dipropylene glycol methylether, propylene glycol methylether, propylene glycol butyl ether, propylene glycol methyl ether acetate or isopropanol, with a solution of a surfactant is used as dispersion agent.

30. Use of the laminate according to claim 16 as floor covering, table top or in the production of furniture.

31. The laminate according to claim 16, wherein the surface modified silica nanoparticles have an average diameter of 3 nm to 200 nm.

32. The laminate according to claim 16, wherein the surface modified silica nanoparticles have an average diameter of 5 nm to 60 nm.

33. The laminate according to claim 16, wherein the top layer comprises the surface modified silica nanoparticles in an amount of 10% to 50%.

34. The laminate according to claim 16, wherein the top layer comprises the surface modified silica nanoparticles in an amount of 20% to 30%.

35. The laminate according to claim 23, wherein the C₁-C₄ alcohol is one of methanol and butanol.
